(19) United States
(12) Patent Application Publication
(10) Pub. No.: US 2012/0194677 A1
(43) Pub. Date: Aug. 2, 2012

(54) LANE MARKER DETECTION SYSTEM WITH IMPROVED DETECTION-PERFORMANCE

(75) Inventor: Shunsuke Suzuki, Anjo-shi (JP)

(73) Assignee: DENSO CORPORATION, Kariya-city (JP)

(21) Appl. No.: 13/357,864

(22) Filed: Jan. 25, 2012

(30) Foreign Application Priority Data
Jan. 27, 2011 (JP) 2011-015466

(51) Int. Cl. H04N 7/18

(52) U.S. Cl. 348/148; 348/E07.085

(57) ABSTRACT

In a lane marker detection system, an image capturing element captures a road image ahead of a vehicle. The road image contains a plurality of color light components individually extractable therefrom. A selecting element extracts color groups from at least one of left and right areas of the road image in front of the vehicle, and selects, from the extracted color groups, one color group. The color groups are comprised of one or more combinations of at least one of the plurality of color light components. The selected one color group has a position in the at least one of the left area and the right area with a contrast equal to or higher than a threshold. The position of the selected one color group is the closest to a boundary between the left and right areas in the extracted color groups.

### CROSS REFERENCE TO RELATED APPLICATIONS

This application is based on Japanese Patent Application 2011-015466 filed on Jan. 27, 2011. This application claims the benefit of priority from the Japanese Patent Application, so that the descriptions of which are all incorporated herein by reference.

### TECHNICAL FIELD

The present disclosure relates to lane marker detection systems to be installed in motor vehicles, and more particularly, to such lane marker detection systems having an improved detection-performance in comparison to that of conventional lane marker detection systems.

### BACKGROUND

Lane markers represent markers in the form of objects or lines to divide a corresponding road into plural parts as lanes. For example, they consist of solid or dashed colored lines, such as while lines, placed on the corresponding road along each lane thereof, or consist of raised markers placed on the corresponding road intermittently along each lane thereof. Thus, in order to improve the running safety of motor vehicles, it is important for the motor vehicles in running one lane of a road ahead thereof to accurately recognize the lane markers formed on the road.

In view of the circumstances, lane marker detection systems are installed in motor vehicles. Such a lane marker detection system installed in a motor vehicle picks up an image (a road image) of a region including a road (road surface) ahead of the motor vehicle, and subjects the road image to image processing to thereby extract edge points indicative of painted lines and/or raised markers. In addition, the lane marker detection system detects lane markers on the road based on the edge points.

Lane markers to be detected by a lane marker detection system are used, in combination of information indicative of the behavior of a corresponding vehicle, such as its travelling direction, travelling speed, and/or steering angle, for prediction of whether a corresponding vehicle will depart from a corresponding lane and/or for automatic control of steering wheel.

In such a lane marker detection method using edge points, the difference in contrast between lanes and the road in a picked-up road image may be reduced depending on the colors and the ambient light of lane markers, such as the colors of painted lines, resulting in reduction of the accuracy of extraction of edge points. This therefore may make it difficult to detect lane markers with high reliability.

In order to enhance the accuracy of detection of lane markers, a lane marker detection system with a specific image-processing camera system is disclosed in Japanese Patent Application Publication No. 2003-32669. The image-processing camera system captures a picked-up road image as individual RGB color signals, and selects one of the possible combinations of the RGB color signals; the selected combination maximizes the contrast between a corresponding road and the lanes located thereon. Then, the image-processing camera system recognizes lane markers based on the selected combination.

For example, the image-processing camera system selects the combination of the R and G color signals, and produces a composite image in yellow based on the R and G color signals. Then, the image-processing camera system recognizes lane markers based on the yellow composite image. This enhances the accuracy of detection of yellow lines as lane markers.

### SUMMARY

It is assumed that the image-processing camera system set forth above tries to detect multicolored composite lane markers, such as carpool lanes (High-occupancy vehicle lanes), which are lanes reserved for vehicles with a driver and one or more passengers, located on a road. In this assumption, even if the image-processing camera system uses one of the possible combinations of the RGB color signals, which maximizes the contrast between the road and a given colored lane marker located thereon, it may not detect another colored lane marker with high accuracy.

For example, if a single white line and four yellow lines are combined as a multicolored composite lane marker, and the image-processing camera system selects one of the possible combinations of the RGB color signals, which maximizes the contrast between the corresponding road and a yellow line, the accuracy of detection of the single white line may be reduced. In detection of a multicolored composite lane marker located on one side of a road, it is important to detect, with high accuracy, the inner most lane marker, which is the closest to vehicles running on a corresponding lane of the road in the combined lane markers of the multicolored composite lane marker. However, if the single white line of the multicolored composite lane marker is located as the innermost lane marker, there is a possibility of misdetection (incorrect-detection) of the while line as the innermost lane marker.

In view of the circumstances set forth above, one aspect of the present disclosure seeks to provide lane-marker detection systems designed to address at least one of the problems set forth above.

Specifically, an alternative aspect of the present disclosure aims to provide such lane-marker detection systems capable of detecting, with high accuracy, a desired lane marker in a multicolored composite lane marker.

According to a first exemplary aspect of the present disclosure, there is provided a lane marker detection system installed in a vehicle. The lane marker detection system captures a picked-up image of a road ahead of the vehicle as a road image. The road image contains a plurality of color light components individually extractable therefrom. The lane marker detection system extracts a plurality of color groups from at least one of a left area and a right area of the road image in front of the vehicle, and selects, from the extracted plurality of color groups, one color group. The plurality of color groups are comprised of one or more combinations of at least one of the plurality of color light components in the at least one of the left area and the right area of the road image. The selected one color group has a position in the at least one of the left area and the right area with a contrast equal to or higher than a threshold. The position of the selected one color group is the closest to a boundary between the left area and the right area in the extracted plurality of color groups. The lane marker detection system extracts one or more edge points from the selected one color group, and a lane marker detecting element that detects, based on the extracted one or more edge points, a lane marker marked on the road ahead of the vehicle.

Even if an innermost lane marker on at least one side of a lane of a road on which the vehicle is running is part of a multicolored composite lane marker, the lane departure alarming system according to the first exemplary aspect of the present disclosure properly detects the innermost lane marker in the multicolored composite lane marker as a desired lane marker.

In the first exemplary aspect of the present disclosure, when a number of color groups are selected from the extracted plurality of color groups, the selecting element is configured to further select, as a target color group, one color group from the selected number of color groups, the position of the selected target color group having the highest contrast in the selected number of color groups, and the edge extracting element is configured to extract the one or more edge points from the selected target color group.

Even if the number of color groups are selected from the extracted plurality of color groups, the lane departure alarming system according to the first exemplary aspect of the present disclosure properly selects one color group from the selected number of color groups as the target color group. The position of the selected target color group has the highest contrast in the selected number of color groups. The lane departure alarming system according to the first exemplary aspect of the present disclosure is configured to extract the one or more edge points from the selected target color group.

In the first exemplary aspect of the present disclosure, the lane departure alarming system can perform the aforementioned lane-marker detection process in only the left area of the road image in front of the vehicle, in only the right area of the road image in front of the vehicle, or in each of the left and right areas of the road image in front of the vehicle. In performing the aforementioned lane-marker detection process in each of the left and right areas of the road image in front of the vehicle, the lane departure alarming system selects a proper color group in individually each of the left and right areas of the road image in front of the vehicle, and properly detects one or more lane markers based on the selected proper color group in individually each of the left and right areas of the road image.

According to a second exemplary aspect of the present disclosure, there is provided a computer program product. The compute program product includes a non-transitory computer-readable medium; and a set of computer program instructions embedded in the computer-readable medium. The instructions includes a first instruction to capture a picked-up image of a road ahead of the vehicle as a road image, the road image containing a plurality of color light components individually extractable therefrom. The instructions includes a second instruction to extract a plurality of color groups from at least one of a left area and a right area of the road image in front of the vehicle, and to select, from the extracted plurality of color groups, one color group. The plurality of color groups are comprised of one or more combinations of at least one of the plurality of color light components in the at least one of the left area and the right area of the road image. The selected one color group has a position in the at least one of the left area and the right area with a contrast equal to or higher than a threshold. The position of the selected one color group is the closest to a boundary between the left area and the right area in the extracted plurality of color groups. The instructions includes a third instruction to extract one or more edge points from the selected one color group, and a fourth instruction to detect, based on the extracted one or more edge points, a lane marker marked on the road ahead of the vehicle.

The above and/or other features, and/or advantages of various aspects of the present disclosure will be further appreciated in view of the following description in conjunction with the accompanying drawings. Various aspects of the present disclosure can include and/or exclude different features, and/or advantages where applicable. In addition various aspects of the present disclosure can combine one or more feature of other embodiments where applicable. The descriptions of features, and/or advantages of particular embodiments should not be constructed as limiting other embodiments or the claims.

### BRIEF DESCRIPTION OF THE DRAWINGS

Other aspects of the present disclosure will become apparent from the following description of embodiments with reference to the accompanying drawings in which:

FIG. 1 is a block diagram schematically illustrating an example of the overall hardware structure of a lane departure alarming system installed in a motor vehicle according to an embodiment of the present disclosure;

FIG. 2 is a flowchart schematically illustrating a lane-departure alarming task to be run by an image-processing ECU illustrated in FIG. 1 according to the embodiment;

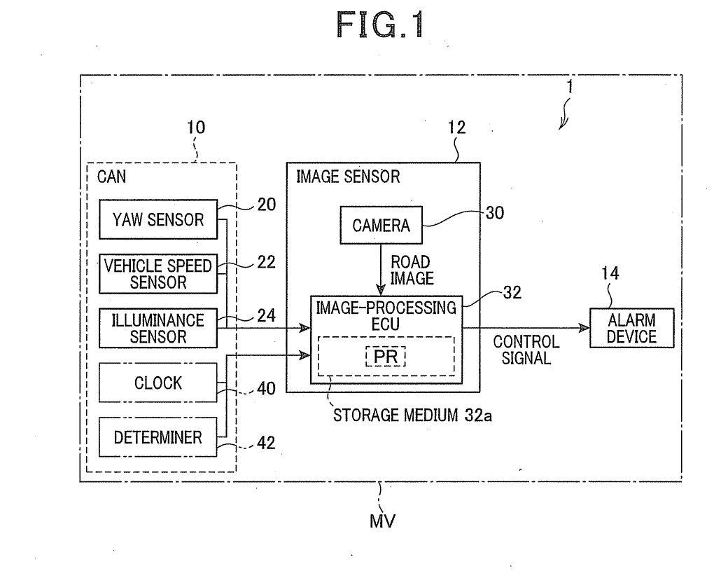

(A) of FIG. 3 is a view schematically illustrating: an example of a road image picked-up by a camera illustrated in FIG. 1;

(B) of FIG. 3 is a graph schematically illustrating a graph of the intensity values of R, G, and B light components of a digital road image on a target check line;

(C) of FIG. 3 is a graph schematically illustrating the combination of the intensity value of the selected R light component in each position of the left area on the same target check line as (B) of FIG. 3 and that of the selected B light component in each position of the right area on the same target check line as (B) of FIG. 3;

(A) of FIG. 4 is a view schematically illustrating the same road image as that illustrated in (A) of FIG. 3;

(B), (C), and (D) of FIG. 4 illustrate the intensity values of the respective R, G, and B light components of each pixel of the digital road image on a target check line; and

FIG. 5 is a flowchart schematically illustrating the determination process in step S4 of FIG. 4 according to the embodiment.

### DETAILED DESCRIPTION OF EMBODIMENT

An embodiment of the present disclosure will be described hereinafter with reference to the accompanying drawings. In the drawings, identical reference characters are utilized to identify corresponding identical components.

This embodiment of the present disclosure is, as an example, applied to a lane departure alarming system 1 installed in a motor vehicle MV as an example of vehicles.

Note that, in the specification, “lane markers” means boundary markers in the form of objects or lines to divide a corresponding road into plural parts as lanes, such as painted colored lines.

Referring to FIG. 1, the lane departure alarming system 1 is comprised of an in-vehicle network 10 provided in the motor vehicle MV, an image sensor 12, and an alarm device 14, such as a buzzer. A plurality of devices including a yaw sensor 20, a vehicle speed sensor 22, and an illuminance sensor 24 are communicably coupled to the image sensor 12 using, for example, the CAN protocol. The image sensor 12 is communicably coupled to the alarm device 14.

The image sensor 12 is comprised of a camera 30 and an image-processing ECU 32 communicably coupled to each other.

The camera 30 is mounted on a portion of the body (outer shell) of the motor vehicle at which the camera 30 can pick up images ahead of the motor vehicle MV. For example, the camera 30 is mounted on the front side of the body (outer shell) of the motor vehicle MV. The camera 30 has a field of view (an area that the camera 30 can pick up), and the field of view includes a predetermined target region including a road (road surface) ahead of the motor vehicle MV.

The camera 30 is operative to successively pick up two-dimensional images (frame images) of a target region at a preset frame rate, such as 1/15 seconds, on a road ahead of the motor vehicle MV; these frame images will be referred to as road images. The vertical direction and horizontal direction of each picked-up road image correspond to the forward direction and the width direction of the vehicle, respectively.

The camera 30 according to this embodiment is configured to pick up road images using the three primary colors (red, green, and blue) as RGB (Red-Green-Blue) images. That is, each of the picked-up road images consists of a plurality of pixels arrayed in matrix; each of the pixels represents the light intensity values (luminance values) of red, green, and blue components of a corresponding location thereof.

As the camera 30, a CCD camera or a CMOS image sensor can be used.

Specifically, a road image picked up by the camera 30 is converted by the camera 30 into a digital road image consisting of digital light intensity values of the red, green, and blue components of each pixel of the road image. The digital road image is outputted from the camera 30 to the image-processing ECU 32. Thus, the camera 30 is configured to successively take road images of the target region on a road (road surface) ahead of the motor vehicle MV, and successively output digital road images corresponding to the taken road images to the image-processing ECU 32.

The image-processing ECU 32 is designed as, for example, a nor mal microcomputer circuit consisting of, for example, a CPU; a storage medium 32a including a ROM (Read Only Memory), such as a rewritable ROM, a RAM (Random Access Memory), and the like; an I/O (Input and output) interface; buses; and so on. The CPU, the storage medium 32a, and the I/O interface are communicably connected with each other via the buses. The storage medium 32a stores therein beforehand various programs including a lane-departure alarming program PR. The lane-departure alarming program PR causes the image-processing ECU 32 to store in the storage medium 32a a digital road image each time the digital road image is received by the image-processing ECU 32 from the camera 30, and to perform a lane detection task based on the digital road image stored in the storage medium 32a.

The yaw sensor 20 is operative to measure the yaw angle (the angle of deviation between the longitudinal axis of the motor vehicle MV and its true direction of motion) or the yaw rate (the rate of change of the yaw angle) of the motor vehicle MV, and output, to the image-processing ECU 32, the measured yaw angle/yaw rate.

The vehicle speed sensor 22 is operative to measure the speed of the motor vehicle MV and output, to the image-processing ECU 32, the measured speed of the motor vehicle MV.

The illuminance sensor 24 is operative to measure the intensity (illuminance) of light incident on the motor vehicle MV, and output, to the image-processing ECU 32, an illuminance signal indicative of the measured intensity of light incident on the motor vehicle MV.

The image-processing ECU 32 is designed to capture the measured yaw angle/yaw rate from the yaw sensor 20, the measured speed of the vehicle MV from the vehicle speed sensor 22, and the illuminance signal outputted from the illuminance sensor 24, and run the lane-departure alarming program PR based on digital road images inputted from the camera 30, and the captured data from the sensors 20, 22, and 24.

That is, the lane-departure alarming program PR causes the image-processing ECU 32 to detect (recognize) lane markers formed on a road in front of the motor vehicle MV, determine whether the motor vehicle MV will depart from a corresponding lane based on the detected lane markers, and output a control signal to the alarm device 14 for requesting the output of an alarm signal when it is determined that the motor vehicle MV will depart from the corresponding lane.

The alarm device 14 is equipped with a speaker and/or a display and operative to output, from the speaker, an audible alarm and/or output, on the display, a visible alarm (warning message) in response to receiving the control signal from the image-processing ECU 32. The audible alarm and the visible alarm, for example, prompt the driver of the motor vehicle MV to operate the steering wheel so as to prevent the lane departure.

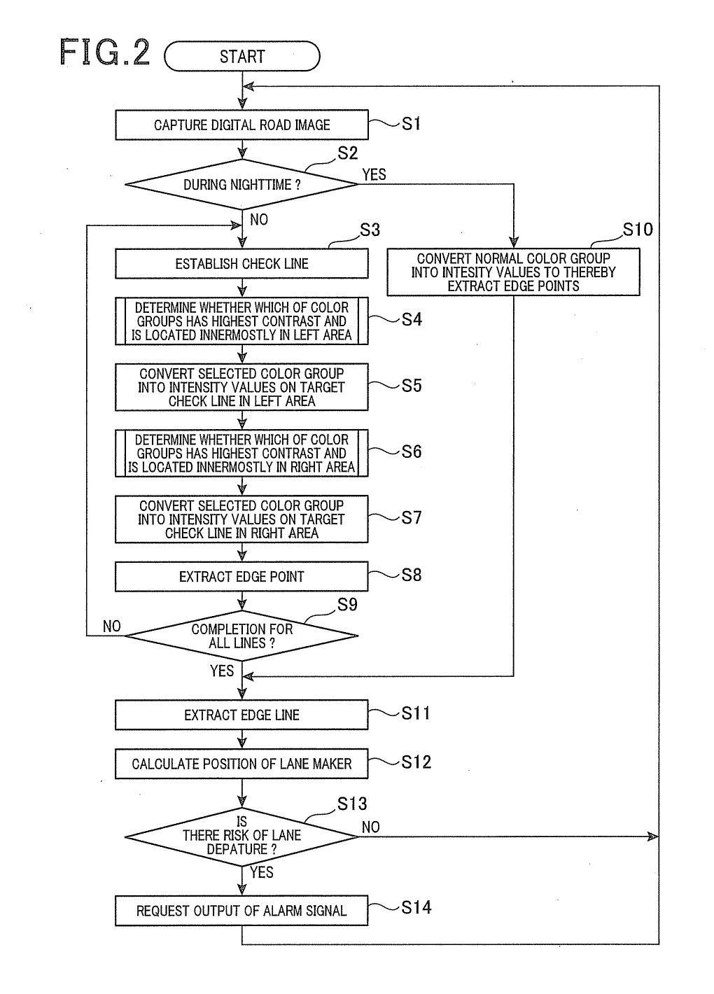

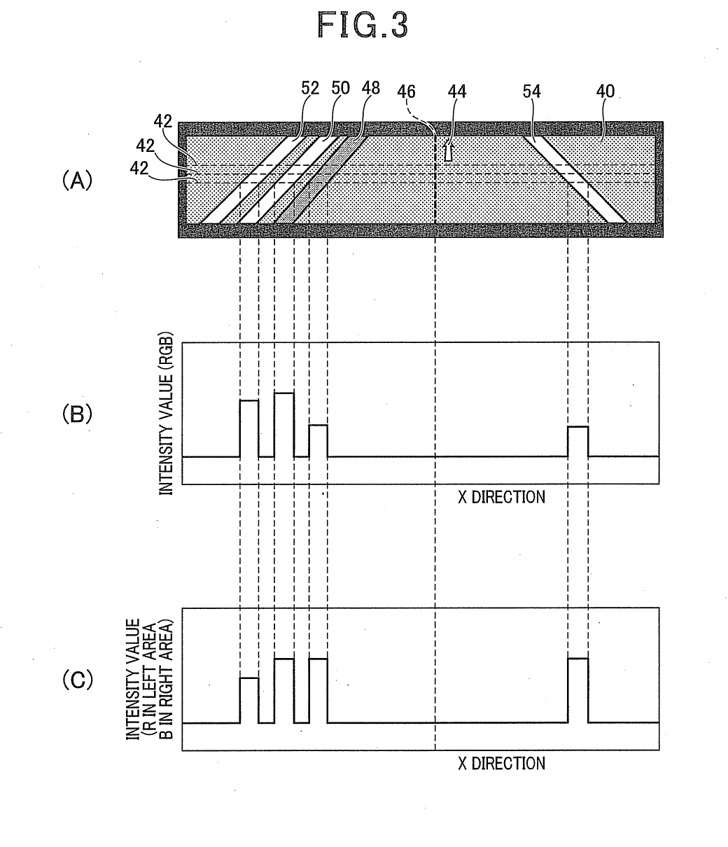

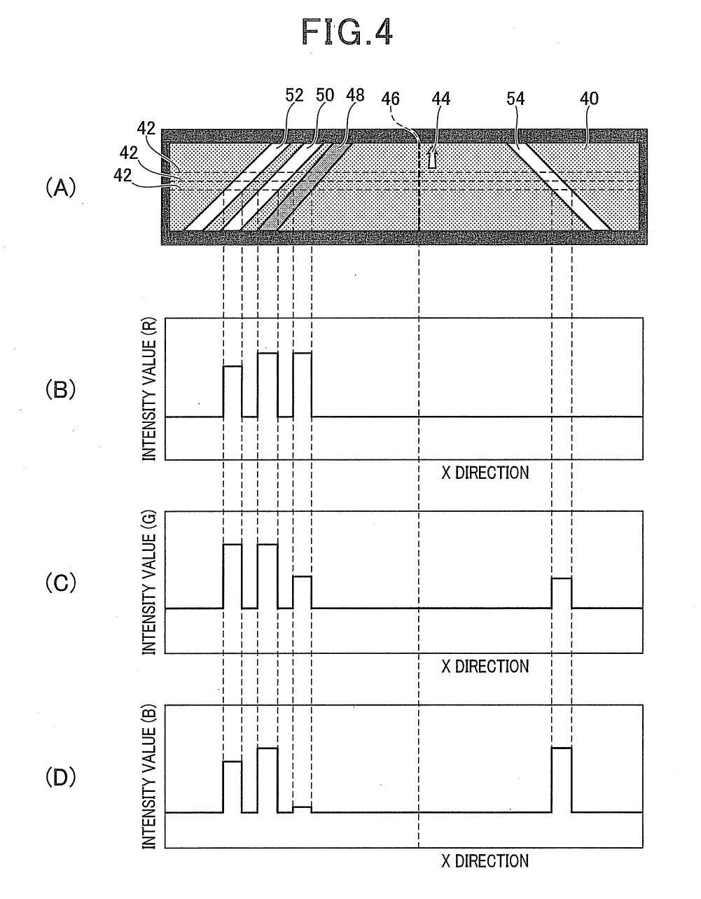

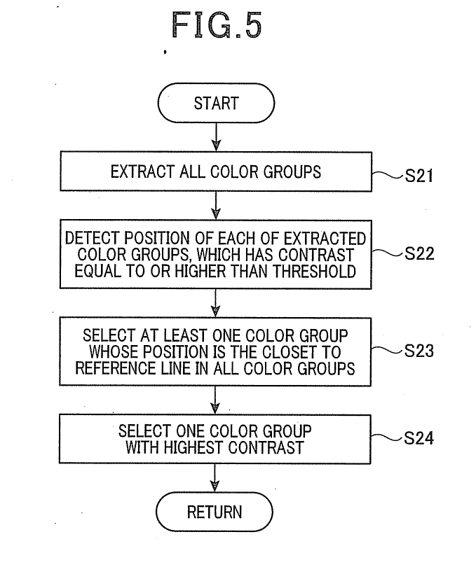

Next, a lane-departure alarming task to be run by the image-processing ECU 32 in accordance with the lane-departure alarming program PR will be described hereinafter with reference to FIGS. 2 to 6. The lane-departure alarming program PR is launched (the lane-departure alarming task is started) when an accessory switch (not shown) is turned on so that the image sensor 12 is energized. The lane-departure alarming task is repeatedly carried out until the accessory switch is turned off so that the image sensor 12 is deenergized.

When launching the lane-departure alarming program PR, the image-processing ECU 32, referred to simply as the ECU 32, captures a digital road image (a current digital road image) corresponding to a current road image picked up by the camera 30 and outputted therefrom, and stores the digital road image in the storage medium 32a in step S1. The operation in step S1 serves as, for example, an image capturing element.

Next, the ECU 32 determines whether the road-image capturing timing is during the nighttime based on the illuminance signal captured from the illuminance sensor 24 in step S2. For example, in step S2, the ECU 32 compares a level of light-intensity on or around the motor vehicle MV based on the illuminance signal with a preset threshold level, and determines whether the level of light-intensity on or around the motor vehicle MV is equal to or higher than the preset threshold level.

When determining that the level of light-intensity on or around the motor vehicle MV is equal to or higher than the preset threshold level, in other words, the illuminance signal represents an illuminance value equal to or higher than a preset illuminance value, the ECU 32 determines that the road-image capturing timing is not during the nighttime (NO in step S2). Then, the ECU 32 proceeds to step S3. Otherwise, when determining that the level of light-intensity on or around the motor vehicle MV is lower than the preset threshold level, in other words, the illuminance signal represents an illuminance value lower than the preset illuminance value, the ECU 32 determines that the road-image capturing timing is during the nighttime (YES in step S2). Then, the ECU 32 proceeds to step S10.

In step S3, the ECU 32 establishes a plurality of check lines 42 on the digital road image stored in the storage medium 32a in the horizontal direction (row direction); each of the check lines 42 is located on a corresponding row of pixels of the digital road image.

(A) of FIG. 3 schematically illustrates an example of a road image 40 picked-up by the camera 30. Referring to (A) of FIG. 3, a multicolored composite lane marker composed of a yellow line 48, white lines 50 and 52, and a blue line 54 is formed (painted) on a picked-up road image 40 along the longitudinal direction of the corresponding road. The yellow line 48 and the white lines 50 and 52 are located on the left side of a corresponding lane of the road, and the blue line 54 is located on the right side of the corresponding lane. The yellow line 48 and the white lines 50 and 52 are arranged from the center of the corresponding lane to the left roadside in this order.

As illustrated in (A) of FIG. 3, the check lines 42 are established on the digital road image corresponding to the road image 40 such that they each extend in the horizontal direction of the road image 40, and cross the forward direction (travelling direction) of the motor vehicle MV; the travelling direction is shown by arrow 44 in (A) of FIG. 3. For example, the check lines 42 are established throughout the digital road image in its vertical direction at regular intervals. In (A) of FIG. 3, some of the check lines 42 are only illustrated as an example.

In addition, in step S3, the ECU 32 establishes a dashed reference line 46 as an example of a marker on the digital road image corresponding to the road image 40, which will be referred to as the digital road image 40, as illustrated in (A) of FIG. 3. The reference line 46 represents points on the road image 40 corresponding to points on the corresponding road through which the center of the motor vehicle MV passes. That is, the reference line 46 is a boundary line that separates the left area and right area in the digital road image 40 in front of the motor vehicle MV.

In the lane-departure alarming task, a point on each check line 42, such as a boundary point between the road surface and a lane marker, at which the light intensity value of a corresponding pixel of the digital road image is sharply changed is extracted as an edge point. In other words, a point on each check line 42 having a high contrast is extracted as an edge point. In the lane-departure alarming task, based on the edge points of all the check lines arranged throughout the digital road image 40 in its vertical direction, the position of one or more lane markers are detected.

Such an edge-point extracting process for each check line 42 is carried out in steps S3 to S8.

In step S3, the ECU 32 selects one check line 42 on which no edge points are extracted, in other words, for which the operations in steps S4 to S8 are not carried out in all the check lines 42 as a target check line 42 for edge-point extraction.

Next, the ECU 32 performs determination of which of color groups has the highest contrast in all the color groups and located innermostly in step S4; the color groups consist of any combination (all possible combinations) of at least one of the color light components, that is, red (R), green (G), and blue (B) light components, extractable from the digital road image 40. In other words, the color groups consist of R, G, or B light component alone or any full or partial combination thereof extractable from the digital road image 40. The operation in step S4 serves as, for example, a selecting element.

In this embodiment, the color groups consist of: the first color group of the R light component, the second color group of the G light component, the third color group of the B light component, the fourth color group of the combination of the R and G light components, the fifth color group of the combination of the R and B light components, the sixth color group of the combination of the G and B light components, and the seventh color group of the combination of the R, G, and B light components. These first to seventh color groups can be extracted from the digital road image 40.

The principle of the determination process in step S4 will be described hereinafter.

The averages of the intensity values of the R, G, and B light components of the respective pixels of the digital road image 40 on one check line 42 are represented as a graph illustrated in (B) of FIG. 3. The average of the intensity values of the R, G, and B light components of a pixel of the digital road image 40 on a check line 42 will be referred to as an “RGB averaged intensity value” hereinafter.

(B) of FIG. 3 shows that the RGB averaged intensity value of a pixel corresponding to a lane marker is higher than the RGB averaged intensity value of a pixel corresponding to the road surface. However, the RGB averaged intensity value of a pixel corresponding to the yellow line 48 or the blue line 54 is lower than that of a pixel corresponding to each of the white lines 50 and 52, and therefore, the contrast of a pixel corresponding to the yellow line 48 or the blue line 54 relative to a pixel corresponding to the road surface is lower than that of a pixel corresponding to each of the white lines 50 and 52 relative to a pixel corresponding to the road surface. In other words, the height of the RGB averaged intensity value of a pixel corresponding to each of the yellow line 48 and the blue line 54 in the graph is lower than that of a pixel corresponding to each of the white lines 50 and 52 in the graph. In the present disclosure, the contrast of a pixel or position, which is referred to as a target pixel or target position, means the contrast of the intensity value of the target pixel or the target position relative to the light intensity of a pixel or position around the target pixel or target position.

In order to increase the contrast of the intensity value of a pixel corresponding to each lane marker to enhance the accuracy of detection of edge points, the principle of the determination process focuses on the intensity value of each of the R, G, and B light components of each pixel of the digital road image on a check line 42. (B), (C), and (D) of FIG. 4 illustrate the intensity values of the respective R, G, and B light components of each pixel of the digital road image on a check line 42. Note that (A) of FIG. 4 is the same view as (A) of FIG. 3. (B), (C), and (D) of FIG. 4 show that the contrast of the boundary between a pixel corresponding to a lane marker and a pixel corresponding to the road surface varies for each of the color groups.

In addition, if there are lane markers on one side of the road surface as illustrated in (A) of each of FIGS. 3 and 4, it is desired to detect, with high accuracy, the innermost lane marker, which is the closest to vehicles running on a corresponding lane of the road. Thus, the principle of the determination process is configured to select, in each of the left and right areas of the road surface separated by the reference line 46, one of the color groups by the following steps. First, at least one color group is selected; the at least one color group has a position (for example, a pixel) or the target check line 42, which has a contrast equal to or higher than a threshold, and the position of the at least one color group is the closest to the reference line 46 in all the color groups. Second, if a plurality of color groups are selected in the first step, one of the plurality of color groups is selected; the position of the selected one of the plurality of color groups has the highest contrast in all the plurality of color groups.

Note that the threshold is previously set to a minimum contrast that allows a position on the target check line 42 corresponding to a lane marker to be reliably determined. That is, another position on the target check line 42 corresponding to a portion on the road surface except for lane markers can be eliminated. This reduces an improper color group from being selected based on a position on the target check line 42 having a contrast lower than the threshold.

For example, in the first, second, third, and seventh color groups illustrated in (B) of FIG. 3 and (B) to (D) of FIG. 4 when the average of the intensity values of the R, G, B light components is used as the seventh color group, the first color group of the intensity value of the R light component is selected for each position in the left area of the digital road image 40 as illustrated in (B) of FIG. 4, and the third color group of the intensity value of the B light component is selected for each position in the right area of the digital road image 40 as illustrated in (D) of FIG. 4. The intensity value of the R light component in each position of the left area on the same target check line as (B) of FIG. 3 and that of the B light component in each position of the right area on the same target check line as (B) of FIG. 3 are combined to be illustrated in (C) of FIG. 3. In comparison to (B) of FIG. 3, (C) of FIG. 3 clearly demonstrates that the intensity value of the R light component of the position in the left area corresponding to the innermost lane marker (yellow line) 46 is higher than the RGB averaged intensity value of the same position in the left area illustrated in (B) of FIG. 3. Similarly, (C) of FIG. 3 clearly demonstrates that the intensity value of the B light component of the position in the right area corresponding to the innermost lane marker (blue line) 54 is higher than the RGB averaged intensity value of the same position in the right area illustrated in (B) of FIG. 3.

Note that the determination process has been described as an example of selecting one color group in the first to third color groups and the seventh color group illustrated in (B) to (D) of FIG. 4 and (B) of FIG. 3; each of the first to third color groups consists of only the intensity value of one-color (R or G or B) light component, and the seventh color group consists of the intensity values of the three-color (RGB) light components. The determination process however can select one color group in the first to seventh color groups; each of the fourth to sixth color groups consists of the intensity values of two-color (RG or RB, or GB) light components. For example, like the seventh color group, the average of the intensity values of two-color light components of a position in the digital road image can be used as the total intensity value of the corresponding two-color light components of the same position in the digital road image.

Surely, the determination process does not need all color groups, such as the first to seventh color groups, extractable from the digital road image as a target of selection of one color group. For example, the determination process can use some of the color groups extractable from the digital road image as a target of selection of one color group without using at least one color group that has a low probability of being selected by the first and second steps set forth above.

Next, specific operations of the determination process in step S4 will be described hereinafter with reference to FIG. 5.

In step S21, the ECU 32 extracts all the color groups, such as the first to seventh color groups, from one of the left area and the right area of the digital road image 40 on the target check line 42 selected in step S3. That is, when performing this operation in step S21 as the subroutine of step S4 of the lane-departure alarming task, the ECU 32 uses the left area of the digital road as a target area from which all the color groups should be extracted. In contrast, when performing this operation in step S21 as the subroutine of step S6 of the lane-departure alarming task described later, the ECU 32 uses the right area of the digital road as a target area from which all the color groups should be extracted.

Next, the ECU 32 detects a position of each of the color groups extracted in step S21; the position has a contrast equal to or higher than the threshold in step S22.

Following step S22, the ECU 32 selects at least one color group in the color groups; the position of the at least one color group is the closest to the reference line 46 in all the color groups in step S23. As described above, in step S23, a plurality of color groups can be selected because the respective color groups extracted from the same digital road image 40 have a high probability of changing in their intensity values at the position of a same object projected on the digital road image 40.

If a plurality of color groups are selected in step S23, the ECU 32 selects one of the plurality of color groups in step S24; the position of the selected one of the plurality of color groups has the highest contrast in all the plurality of color groups. Otherwise, if one color group is selected in step S23, the ECU 32 selects the one color groups in step S24. After completion of the operation in step S24, the ECU 32 terminates the determination process in step S4, and shifts to the next operation in step S5 of the lane-departure alarming task.

In step S5 illustrated in FIG. 2, the ECU 32 converts the selected color group in step S24 of step S4 into the corresponding intensity values on the target check line 42 in the left area of the digital road image 40.

Next, the ECU 32 performs determination of which of color groups has the highest contrast in all the color groups and located innermostly in step S6 in the same manner as the operation in step S4 using the right area of the digital road image 40 as a target of color-group selection area. The operation in step S6 serves as, for example, a selecting element.

After completion of the operation in step S6, the ECU 32 converts the selected color group in step S24 of step S6 into the corresponding intensity values on the target, check line 42 in the right area of the digital road image 40 in step S7.

In step S8, the ECU 32 differentiates the intensity value of each pixel on the target check line 42 in each of the left and right areas of the digital load image, and extracts pixels each with the differentiated value being a local maximum value or a local minimum value as edge points. In step S8, the ECU 32 stores the extracted edge points in the storage medium 32a in correlation with the corresponding target check line 42 selected in step S3. The operations in steps S5, S7, and S8 serve as, for example, an edge extracting element.

Next, the ECU 32 determines whether the operations in step S4 to S8 to extract edge points have been carried out for all the check lines 42 in step S9. When determining that the operations in step S4 to S8 to extract edge points have not been carried out yet for all the check lines 42 (NO in step S9), the ECU 32 returns to step S3. Then, in step S3, the ECU 32 selects a new check line 42 as the target check line 42, and repeatedly carries out the operations in steps S4 to S9 until the determination in step S9 is affirmative.

Thus, when determining that the operations in step S4 to S8 to extract edge points have been carried out for all the check lines 42 (YES in step S9), the ECU 32 proceeds to step S11.

On the other hand, when determining that the road-image capturing timing is during the nighttime (YES in step S2), the ECU 32 converts a normal color group into the corresponding intensity values on the target check line 42 in the digital road image 40 in step S10; the normal color group is the seventh color group of the intensity values of the R, G, and B light components illustrated in (B) of FIG. 3. That is, the averages of the intensity values of the R, G, and B light components of the respective pixels of the digital road image 40 on the target check line 42 are obtained in step S10. Then, in step S10, the ECU 32 differentiates the intensity value of each pixel on each check line 42 in the digital load image 40, and extracts pixels each with the differentiated value being a local maximum value or a local minimum value as edge points in the same manner as the operation in step S8. In step S10, the ECU 32 stores the extracted edge points in the storage medium 32a in correlation with each of the corresponding check lines 42, shifting to step S11.

In step S11, the ECU 32 extracts edge lines in the digital road image 40 based on all the edge points extracted in step S8 or S10 and stored in the storage medium 32a, that is, all, the edge points based on the captured digital road image 40 in step S1. For example, in step S11, the ECU 32 subjects all the edge points to the Hough transform, and extracts edge lines in a plurality of edge lines; each of the extracted edge lines passes through the largest number of edge points in all the edge points on each side of the motor vehicle MV in the travelling direction. In step S8, in place of the differentiation method, in order to extract edge points, the known Canny method can be used.

In step S12, the ECU 32 stores, in the storage medium 32a, the extracted edge lines. Specifically, the edge lines that have been extracted for each of a preset number of previous frame images (road images) 40 have been stored in the storage medium 32a. That is, in step S12, the ECU 32 calculates positions of lane markers based on the extracted edge lines.

For example, in step S12, the ECU 32 samples, from the storage medium 32a, a number of temporally adjacent extracted edge lines including the currently extracted edge lines from the corresponding number of frames (road images). For example, in this embodiment, the ECU 32 samples, from the storage medium 32a, three temporally adjacent extracted edge lines including the currently extracted edge lines from the corresponding three frames (road images 40). Then, the ECU 32 calculates positions of lane markers based on the sampled edge lines to thereby recognize a lane on which the motor vehicle MV is running based on the calculated positions of the lane markers.

In step S12, the ECU 32 calculates a distance of the motor vehicle MV to each of the recognized lane markers. The operations in steps S11 and S12 serve as, for example, a lane marker detecting element.

Next, in step S13, the ECU 32 determines whether the motor vehicle MV will depart from the recognized lane based on the calculated positions of the lane markers, calculated distances, the measured yaw angle/yaw rate, and the measured speed of the motor vehicle MV. Specifically, the ECU 32 predicts a future running pass of the motor vehicle MV based on the measured yaw angle/yaw rate and the measured speed of the motor vehicle MV. Then, the ECU 32 calculates, based on the calculated positions of the lane markers, calculated distance of the motor vehicle MV to each of the recognized lane markers, and the predicted future running pass, a time required for the motor vehicle MV to depart from the lane, on which the motor vehicle MV is running, which is constructed by the lane markers.

In step S13, the ECU 32 determines whether the calculated time is equal to or larger than a preset threshold, such as 1 second in this embodiment.

When the calculated time is equal to or larger than the preset threshold (NO in step S13), the ECU 32 determines that the motor vehicle MV will not depart from the lane on which the motor vehicle MV is running, returning to step S1, and carries out the operations in steps S1 to S13 based on a current digital road image 40 captured from the camera 30. In other words, the ECU 32 repeatedly carries out the operations in steps S1 to S13 each time a digital frame image is captured as a current digital road image 40.

Otherwise, when the calculated time is smaller than the preset threshold (YES in step S13), the ECU 32 determines there is a risk of lane departure of the motor vehicle MV, then outputting the control signal to the alarm device 14 for requesting the output of an alarm signal in step S14.

As a result, the alarm device 14 outputs, from the speaker, an audible alarm and/or outputs, on the display, a visible alarm (warning message) in response to receiving the control signal from the ECU 32. The audible alarm and the visible alarm prompt the driver of the motor vehicle MV to operate the steering wheel so as to prevent the lane departure.

As described above, even if the innermost lane marker on at least one side of a lane of a road on which the motor vehicle MV is running is part of a multicolored composite lane marker, the lane departure alarming system 1 according to this embodiment properly detects the innermost lane marker in the multicolored composite lane marker as a desired lane marker.

In addition, if the road-image capturing timing is during the nighttime in which lane markers projected on the road image 40 are sensitive to the headlight of the motor vehicle MV or another vehicle and the light-intensity contrast of each lane marker relative to the road surface is likely to be high, the lane departure alarming system 1 according to this embodiment skips the operations in steps S4 to S7. This configuration reduces the processing load of the ECU 32.

The present disclosure is not limited to the aforementioned embodiment, and can be applied to various modified embodiments within the scope of the present disclosure.

For example, the lane departure alarming system 1 according to this embodiment is configured to select one color group in each of the left and right sides of the digital road image separated by the reference line 46, but the present disclosure is not limited thereto. Specifically, the lane departure alarming system 1 according to this embodiment can be configured to select one color group in either the left side or the right side of the digital road image, or in only one of the left and right sides of the digital road image; the only one of the left and right sides meets a preset criterion. The preset criterion is when it is determined that there are a plurality of lane markers on the one of the left and right sides by a determining means.

The lane departure alarming system 1 according to this embodiment is configured to determine whether the road-image capturing timing is during the nighttime based on the illuminance signal captured from the illuminance sensor 24, but the present disclosure is not limited thereto. Specifically, the lane departure alarming system 1 can be configured to determine whether the road-image capturing timing is during the nighttime based on time-of-day information outputted from a clock 40 installed in the motor vehicle MV, such as a real-time clock (see the chain double-dashed line 40 in FIG. 1). The time range corresponding to the nighttime can be set to, for example, the range from 6:00 p.m. to 6:00 a.m. according to the region at which the motor vehicle MV is running, the current season, and so on because the ambient light depends on the region and the current season.

The lane departure alarming system 1 can be configured to determine that the road-image capturing timing is during the nighttime when a determiner (see the chain double-dashed line 42 in FIG. 1) determines that the headlight of the motor vehicle MV is on.

The lane departure alarming system 1 according to this embodiment is configured to pick up a road image consisting of the three primary colors (RGB) by the camera 30, and use color groups consisting of any combination of at least one of the red (R), green (G), and blue (B) light components, extractable from the digital road image, but the present invention is not limited thereto. Specifically, the lane departure alarming system 1 can be configured to use color groups consisting of any combination of at least one of a luminance signal component and color-difference signal components extracted from the digital road image; these luminance signal component and color-difference signal components can be equivalently transformed to the three-primary color light components (R, G, and B light components).

The lane departure alarming system 1 according to this embodiment is configured to establish the reference line 46 on the digital road image at a predetermined position, but establish it as a dynamic line. For example, the lane departure alarming system 1 can be configured to bend the dynamic reference line 46 in the turning direction of the motor vehicle MV according to the measured yaw angle/yaw rate.

The lane departure alarming system 1 according to this embodiment is configured to establish a plurality of check lines 42 on the digital road image such that they each extend in the horizontal direction of the road image 40, and cross the forward direction (travelling direction) of the motor vehicle MV, and detect edge points on each of the check lines 42, but the present disclosure is not limited thereto. The lane departure alarming system 1 can be configured to detect edge points from color groups extracted from a picked-up road image without using the check lines 42.

While an illustrative embodiment of the present disclosure have been described herein, the present disclosure is not limited to the embodiment described herein, but includes any and all embodiments having modifications, omissions, combinations (e.g., of aspects across various embodiments), adaptations and/or alternations as would be appreciated by those in the art based on the present disclosure. The limitations in the claims are to be interpreted broadly based on the language employed in the claims and not limited to examples described in the present specification or during the prosecution of the application, which examples are to be constructed as non-exclusive.

What is claimed is:

1. A lane marker detection system installed in a vehicle, comprising:
an image capturing element that captures a picked-up image of a road ahead of the vehicle as a road image, the road image containing a plurality of color light components individually extractable therefrom;
a selecting element that extracts a plurality of color groups from at least one of a left area and a right area of the road image in front of the vehicle, and selects, from the extracted plurality of color groups, one color group, the plurality of color groups being comprised of one or more combinations of at least one of the plurality of color light components in the at least one of the left area and the right area of the road image, the selected one color group having a position in the at least one of the left area and the right area with a contrast equal to or higher than a threshold, the position of the selected one color group being the closest to a boundary between the left area and the right area in the extracted plurality of color groups;
an edge extracting element that extracts one or more edge points from the selected one color group; and
a lane marker detecting element that detects, based on the extracted one or more edge points, a lane marker marked on the road ahead of the vehicle.

2. The lane marker detection system according to claim 1, wherein, when a number of color groups are selected from the extracted plurality of color groups, the selecting element is configured to further select, as a target color group, one color group from the selected number of color groups, the position of the selected target color group having the highest contrast in the selected number of color groups, and the edge extracting element is configured to extract the one or more edge points from the selected target color group.

3. The lane marker detection system according to claim 1, wherein the selecting element is configured to:
establish a check line on the at least one of the left area and the right area of the road image, the check line extending in a horizontal direction of the road image corresponding to a width direction of the vehicle, and crossing a direction corresponding to a travelling direction of the vehicle; and
extract, from the at least one of the left area and the right area of the road image, the plurality of color groups on the check line established on the at least one of the left area and the right area of the road image.

4. The lane marker detection system according to claim 1, wherein the plurality of color light components are comprised of a red component, a green component, and a blue component, and the plurality of color groups are comprised of two or more of: the red component, the green component, the blue component, any combination of two of the red, green, and blue components, and a combination of the red, green, and blue components.

5. The lane marker detection system according to claim 1, further comprising:
a determining element configured to determine that at least one of first, second, and third conditions is met, the first condition being that a level of light-intensity on or around the vehicle is equal to or lower than a preset threshold level, the second condition being that a timing of capturing the road image is during a nighttime based on time-of-day information, the third condition being that a headlight of the vehicle is on,
wherein the selecting element is configured to select all possible combinations of the at least one of the plurality of color light components in the at least one of the left area and the right area of the road image.

6. The lane marker detection system according to claim 1, further comprising a reference line establishing element that establishes a marker on the road image captured by the image capturing element, the marker representing the boundary between the left area and the right area in the road image.

7. The lane marker detecting system according to claim 3, wherein the selecting element is configured to:
establish, on the at least one of the left area and the right area of the road image, the check line in plurality, each of the plurality of check lines extending in the horizontal direction of the road image and crossing the direction corresponding to the travelling direction of the vehicle, the plurality of check lines being located on the at least one of the left area and the right area of the road image in a direction orthogonal to the horizontal direction at regular intervals; and
extract, from the at least one of the left area and the right area of the road image, the plurality of color groups on each of the plurality of check lines established on the at least one of the left area and the right area of the road image.

8. A computer program product comprising:
a non-transitory computer-readable medium; and
a set of computer program instructions embedded in the computer-readable medium, the instructions including:
a first instruction to capture a picked-up image of a road ahead of the vehicle as a road image, the road image containing a plurality of color light components individually extractable therefrom;
a second instruction to extract a plurality of color groups from at least one of a left area and a right area of the road image in front of the vehicle, and to select, from the extracted plurality of color groups, one color group, the plurality of color groups being comprised of one or more combinations of at least one of the plurality of color light components in the at least one of the left area and the right area of the road image, the selected one color group having a position in the at least one of the left area and the right area with a contrast equal to or higher than a threshold, the position of the selected one color group being the closest to a boundary between the left area and the right area in the extracted plurality of color groups;
a third instruction to extract one or more edge points from the selected one color group; and
a fourth instruction to detect, based on the extracted one or more edge points, a lane marker marked on the road ahead of the vehicle.
